(19) United States
(12) Patent Application Publication
(10) Pub. No.: US 2005/0238819 A1
(43) Pub. Date: Oct. 27, 2005

(54) Apparatus for applying adhesive

(76) Inventors: Konrad Beretitsch, Altenmarkt (DE); Matthias Von Hayek-Boelingen, Bremen (DE); Juergen Von Czarnecki, Berglern (DE)

Correspondence Address: HENKEL CORPORATION, THE TRIAD, SUITE 200, 2200 RENAISSANCE BLVD., GULPH MILLS, PA, 19406, US

(21) Appl. No.: 11/084,530

(22) Filed: Mar. 18, 2005

(30) Foreign Application Priority Data
Mar. 20, 2004 (DE) DE 102 00401 3845

(51) Int. Cl. B32B 31/00; B05D 5/10

(52) U.S. Cl. 427/600; 156/578; 156/73.1; 427/207.1

(57) ABSTRACT

An apparatus for applying adhesive onto a joining surface of an adherend is provided which eliminates laborious cleaning and surface-pretreatment steps prior to application of the adhesive onto the substrate surface. Sufficient adhesive bond quality can thereby be ensured even when the joining surface is unavoidably contaminated or recontaminated. The apparatus comprises a sonotrode and a conduit for the delivery of adhesive arranged in the sonotrode. The conduit comprises an adhesive outlet opening that is arranged in the region of the exposed head end of the sonotrode. The sonotrode is configured so that in operation, the vibrations of the sonotrode are transferred to the adhesive emerging from the adhesive outlet opening.

### CROSS-REFERENCE TO RELATED APPLICATION

This application claims priority under 35 U.S.C. Section 119 from German application DE 102004013845.1, filed 20 Mar. 2004.

### FIELD OF THE INVENTION

The invention concerns an apparatus for applying adhesive onto a contaminated joining surface of an adherend.

### DISCUSSION OF THE RELATED ART

The field of adhesive-bonding joining methods is characterized by an increasing number of applications and great potential for innovation. Adhesive bonding is ideal for lightweight construction applications, and in particular for the repair sector. The strength achievable in an adhesive bond is determined by the adhesion between the adhesive and the adherend surface. The strength results from the work of adsorption performed in the interface, at an atomic level, via short-range interactions. Adhesion-reducing contamination is a problem in adhesive technology. No matter how much care is taken, such contamination cannot be completely ruled out in practice, and the insufficient adhesion that results cannot, unfortunately, be nondestructively tested. The elimination of adhesion-reducing contaminants is problematic even in the production of new parts under controlled industrial conditions, and is even more difficult, because of the greater number of possible unknown contamination sources, in repair applications on aged and media-affected adherends. The contamination tolerance of the adhesive technology process is therefore an indispensable quality assurance requirement, and a challenge for adhesive research. The emphasis is not on new high-strength adhesives and the strength that can be achieved in an adhesive bond: the application criterion is reliability.

A need therefore exists for methods and corresponding apparatuses for adhesive bonding of contaminated adherends. The intention is to eliminate laborious cleaning and surface-pretreatment steps prior to application of the adhesive onto the substrate surface, and furthermore to ensure sufficient adhesive bonding quality if contamination or recontamination cannot be eliminated.

German application DE 103 12 815 A1 describes a method for adhesive bonding of contaminated adherends in which the contaminating constituents of the adherend surfaces are removed from the interface by the introduction of vibrational energy (ultrasound) into the as-yet uncured adhesive matrix, and are dissolved or dispersed in the adhesive matrix; wetting of the surface is thereby improved. The apparatus for applying adhesive can be coupled directly to the sonotrode.

The use of ultrasound in general for the treatment of adhesives in adhesive joins is described in DE 42 26 312 A1, JP 63132788 A, JP 2000073031, and U.S. Pat. No. 6,544,364 B2. These essentially involve at least the generation of locally limited thermal energy for curing or melting.

The application of ultrasound to the mixing of different coating components on the respective join surfaces is evident from DD 205 180 and JP 01259080 A. Here an adhesive component on the one joining surface is mixed with a corresponding hardener component on the other joining surface so that curing can take place. JP 06057229 A indicates that this is applicable not only to mixing with a curing component but also to components that are poorly compatible with the adhesive.

Certain adhesives for adhesive joining of contaminated components in automobile body construction, specifically components in most cases having residues containing oils, are known from DE 198 58 921 A1 and DE 195 02 381 A1.

It would be desireable to create an apparatus for applying adhesive onto a joining surface of an adherend, which apparatus eliminates laborious cleaning and surface-pretreatment steps prior to application of the adhesive onto the substrate surface, and with which sufficient adhesive bond quality can be ensured even in the context of unavoidable contamination or recontamination; and which moreover works effectively.

### BRIEF SUMMARY OF THE INVENTION

The present invention provides an apparatus for applying adhesive onto a contaminated joining surface of an adherend, wherein said apparatus exhibits the following features:
the apparatus encompasses a sonotrode;
a conduit for the delivery of adhesive is arranged in the sonotrode;
the conduit comprises an adhesive outlet opening that is arranged in the region of the exposed head end of the sonotrode;
the sonotrode is configured so that in operation, the vibrations of the sonotrode are transferred to the adhesive emerging from the adhesive outlet opening.

The advantages of the invention are described below.

### BRIEF DESCRIPTION OF THE DRAWING

FIG. 1 illustrates in schematic form an embodiment of an apparatus in accordance with the invention.

### DETAILED DESCRIPTION OF CERTAIN EMBODIMENTS OF THE INVENTION

The vibrations of the sonotrode are transferred to the adhesive emerging from the adhesive outlet opening. In that context, the contaminating constituents of the adherend surface are removed from the interface as a result of the introduction of vibrational energy or ultrasound into the as-yet uncured adhesive matrix, and are dissolved or dispersed in the adhesive matrix, thereby improving wetting of the surface. Incoupling of ultrasound into the uncured adhesive causes the adhesive to absorb the contamination, resulting in an undisrupted interaction between adhesive and adherend.

The final cleaning process, which is critical to the strength of the adhesive bond, is transferred directly to the adhesive being used, and the possibility of further recontamination is reliably excluded. Finish cleaning of the adherend surface occurs in the adhesive under the influence of the ultrasonic power of the sonotrode. The adhesive serves, in this context, simultaneously as a coupling and a cleaning medium, and adhesion-reducing interface contaminants are removed from the interface. Only then does the adhesive cure, and a load-bearing bond is produced.

The contamination-tolerant action of the method is based on several effects. The incoupling of ultrasound results in improved adherend wetting, detachment and clearance of contaminants by cavitation, removal of capillary inclusions from the adherend surface, and homogenization of the adhesive.

The apparatus for applying adhesive is usable with pasty adhesives in general. It is suitable for both hot- and, in particular, cold-curing adhesive systems, which can be embodied in one- and two-component fashion.

The apparatus for applying adhesive can be used manually, for example for the repair sector, but also can be automated in any desired manner.

The fact that the conduit for the delivery of adhesive is arranged in the sonotrode, and the conduit comprises an adhesive outlet opening that is arranged in the region of the exposed head end of the sonotrode, results in high efficiency and economy, since the sub-task of adhesive application and the sub-task of treatment with ultrasound are combined into one single working step. In addition, reliable coupling of the ultrasound into the adhesive, and therefore onto the interface to be treated, is achieved. The sonotrode can be embodied so that during operation, it floats over the adherend on an adhesive film of defined thickness. With the delivery of adhesive through the sonotrode, improved mixing and homogenization of the adhesive already occur in the sonotrode. This process in turn additionally improves the properties of the adhesive bond. It furthermore improves the quality of the adhesive bead in terms of shape and requisite volume. Because the quantity of adhesive to be applied can be precisely adjusted, the amount of adhesive is reduced to what is required, preventing adhesive from being unnecessarily squeezed out of the join.

In one embodiment of the apparatus according to the present invention for applying adhesive, the conduit comprises an adhesive inlet opening that is arranged in the enveloping surface of the sonotrode in the region of the vibration node. The result of this feature is that the adhesive inlet opening, which is equipped, for example, with a tubing connector, is exposed to only a small mechanical load as a result of lower vibration amplitudes.

According to a further embodiment of the invention, the adhesive outlet opening is arranged in the end surface of the exposed head end of the sonotrode. This makes possible a simple mechanical configuration, since when the apparatus is in operation, the adhesive emerges from the end surface of the exposed head end and is applied onto a contaminated joining surface of an adherend. Ultrasonic treatment occurs simultaneously, once again via the end surface of the exposed head end of the sonotrode floating on the adhesive.

According to a further embodiment of the invention, the conduit is constituted by a longitudinal orifice extending through the adhesive outlet opening and a transverse orifice extending through an adhesive inlet opening. This simple configuration results in a sonotrode that has an integrated conduit for the delivery and application of adhesive and is inexpensive to manufacture.

According to a further embodiment of the invention, the apparatus comprises an adhesive pump that is connected to a regulating circuit for regulating the quantity of adhesive delivered. The prerequisites are thereby created for automating the application of adhesive simultaneously with ultrasound treatment. The apparatus for applying adhesive can, for example, be mounted on a robot arm.

According to a further embodiment of the invention, the regulating circuit is embodied so that in operation, it is acted upon by an input variable that corresponds to the value of the power consumption of the ultrasonic generator. The power consumption of the sonotrode is a direct indication of the incoupling of ultrasound into the adhesive, and the quality of the treatment of the adhesive/adherend interface. The power consumption therefore represents a very important input variable for regulating the quantity of adhesive delivered, in order also to ensure incoupling of a sufficiently high energy level with respect to the quantity of adhesive delivered. The film thickness, determined principally by the viscosity and the quantity delivered, can thus be given a reproducible interface treatment by way of a sufficient incoupling of ultrasonic power.

According to a further embodiment of the invention, a temperature sensor is arranged in the region of the exposed head end of the sonotrode. The temperature sensor is preferably arranged in the region of the adhesive outlet opening, so that the adhesive temperature can be sensed as accurately as possible. To refine the regulation of the quantity of adhesive delivered, the regulating circuit can be acted upon during operation by a further input variable that corresponds to the temperature that was ascertained by the temperature sensor. The temperature variable ascertained by the temperature sensor also represents, in indirect and time-delayed fashion, an indication of the value of the sonotrode's power consumption. Diffusion, dissolution, and/or dispersion of the contaminating impurities on the substrate surface into the adhesive matrix is promoted by an elevation of the temperature of the adhesive. In addition to the sonotrode power consumption variable, the temperature variable ascertained by the temperature sensor is also suitable for ensuring the quality of the adhesive bond. It can be stipulated, for example, that a temperature range from 50° C. to 60° C. be complied with. In automated operation, the temperature variable and/or the sonotrode power consumption variable can be recorded in the context of quality assurance.

The invention will be described in more detail below with reference to an exemplifying embodiment presented in the drawings.

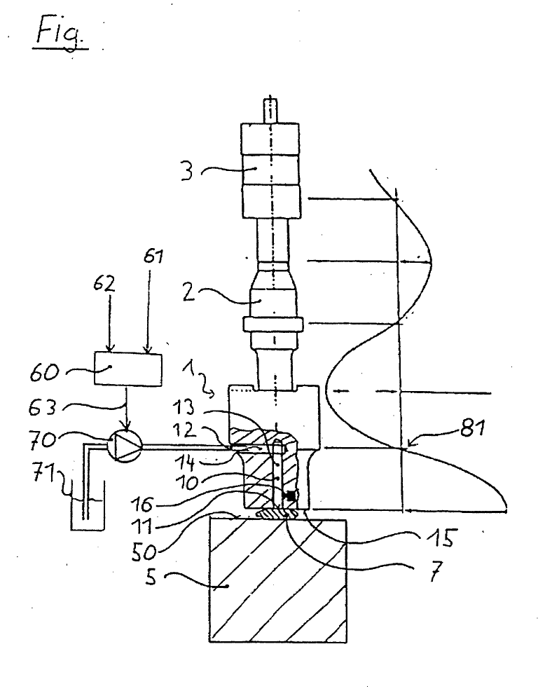

FIG. 1 shows an apparatus for applying adhesive onto a contaminated joining surface 50 of an adherend 5. The apparatus encompasses a sonotrode 1 in which a conduit 10 for the delivery of adhesive is arranged. This conduit 10 comprises an adhesive outlet opening 11 that is arranged in the region of the exposed head end of sonotrode 1. Sonotrode 1 is configured so that in operation, the vibrations of sonotrode 1 are transferred to the adhesive emerging from adhesive outlet opening 11.

Sonotrode 1 is part of an ultrasound head that also comprises, in addition to sonotrode 1, a piezoresonator 3 and a coupling element 2.

The conduit comprises an adhesive inlet opening 12 that is arranged in the enveloping surface of the sonotrode in the region of vibration node 81. Vibration node 81 is illustrated by a graphical depiction in which the vibration amplitudes are plotted against the length of the ultrasound head.

Adhesive outlet opening 11 is arranged in the end surface of the exposed head end of sonotrode 1. Depicted below adhesive outlet opening 11 is an adhesive bead 7 that has been applied onto a contaminated joining surface 50.

Conduit 10 is constituted by a longitudinal orifice 13 extending through adhesive outlet opening 11, and a transverse orifice 14 extending through adhesive inlet opening 12.

The apparatus comprises an adhesive pump 70 that is connected via a line 63 to a regulating circuit 60 for regulating the quantity of adhesive delivered.

Regulating circuit 60 is configured so that in operation, it is acted upon by an input variable that corresponds to the value of the sonotrode's power consumption. This is illustrated by input line 61.

A temperature sensor 16 is arranged in the region of the exposed head end of sonotrode 1. As depicted, temperature sensor 16 is located in the region of adhesive outlet opening 11. Regulating circuit 60 is acted upon, during operation, by a further input variable that corresponds to the temperature that was ascertained by temperature sensor 16. This is illustrated by input line 62. In the context of quality assurance, regulating circuit 60 is equipped with an electronic memory in order to record both the temperature variable and the sonotrode power consumption variable.

The example that follows is intended to elucidate the fact that with the apparatus for applying adhesive, a high-strength adhesive bond can be achieved even with a contaminated joining surface.

A double cantilever beam (DCB) specimen, comprising two limbs to be adhesively bonded to one another, is used in the example, One of the limbs has hydraulic oil residues, specifically 3 grams/m², on the joining surface. Terokal 5045® ((a product of Henkel) is used as the adhesive. The adhesive was applied onto the joining surface of the contaminated limb using the apparatus depicted in FIG. 1, with simultaneous introduction of ultrasound. The sonotrode had a power consumption of 100 watts during adhesive application. Adhesive outlet opening 11 had a diameter of 3 mm. The head of sonotrode 1 floated on an adhesive thickness of approximately 0.9 mm. The uncontaminated limb was then pressed onto the contaminated limb and immobilized. After curing, the quality of the adhesive bond was ascertained using the DCB test. In this, a cohesion failure occurred that suggests an undisrupted adhesive effect between the adhesive and adherend. For comparison, a further DCB specimen was produced without ultrasound incoupling. This, in contrast to the previously described specimen treated with ultrasound, exhibited an adhesion failure at the contaminated joining surface of the contaminated limb. The energy release rate of the specimen that was not treated with ultrasound was 0.109 N/mm², less than one-fifth that of the ultrasound-treated specimen (0.590 N/mm²).

1. An apparatus for applying an adhesive onto a contaminated joining surface of an adherend, said apparatus comprising:
a) a sonotrode having an exposed head end; and
b) a conduit in the sonotrode for delivering said adhesive, wherein said conduit comprises an adhesive outlet opening in the region of the exposed head end of the sonotrode;
wherein said sonotrode is configured so that when said appatus is operated the vibrations of the sonotrode are transferred to the adhesive emerging from the adhesive outlet opening.

2. The apparatus of claim 1, wherein the conduit comprises an adhesive inlet opening in the enveloping surface of the sonotrode in the region of a vibration node.

3. The apparatus of claim 1, wherein the adhesive outlet opening is arranged in the end surface of the exposed head end of the sonotrode.

4. The apparatus of claim 1, wherein the conduit comprises a longitudinal orifice extending through the adhesive outlet opening and a transverse orifice extending through an adhesive inlet opening.

5. The apparatus of claim 1, additionally comprising an adhesive pump that is connected to a regulating circuit for regulating the quantity of the adhesive delivered.

6. The apparatus of claim 5, wherein the regulating circuit is acted upon by an input variable that corresponds to the value of the power consumption of the sonotrode.

7. The apparatus of claim 1, wherein a temperature sensor is arranged in the region of the exposed head end of the sonotrode.

8. The apparatus of claim 1, additionally comprising an adhesive pump connected to a regulating circuit for regulating the quantity of adhesive delivered by the apparatus and a temperature sensor arranged in the region of the exposed head end of the sonotrode, wherein the regulating circuit can be acted upon during operation of the apparatus by an input variable corresponding to the temperature ascertained by the temperature sensor.

9. The apparatus of claim 1, wherein a) the conduit comprises an adhesive inlet opening in the enveloping surface of the sonotrode in the region of a vibration node, a longitudinal orifice extending through the adhesive outlet opening and a transverse orifice extending through the adhesive inlet opening, b) the adhesive outlet opening is arranged in the end surface of the exposed head end of the sonotrode, c) the apparatus additionally comprises an adhesive pump that is connected to a regulating circuit for regulating the quantity of the adhesive delivered, d) the regulating circuit is acted upon by an input variable that corresponds to the value of the power consumption of the sonotrode, and e) a temperature sensor is arranged in the region of the exposed head end of the sonotrode.

10. The apparatus of claim 1, wherein a) the conduit comprises an adhesive inlet opening in the enveloping surface of the sonotrode in the region of a vibration node, a longitudinal orifice extending through the adhesive outlet opening and a transverse orifice extending through the adhesive inlet opening, b) the adhesive outlet opening is arranged in the end surface of the exposed head end of the sonotrode, c) the apparatus additionally comprises an adhesive pump that is connected to a regulating circuit for regulating the quantity of the adhesive delivered, and d) the regulating circuit is acted upon by an input variable that corresponds to the value of the power consumption of the sonotrode.

11. The apparatus of claim 1, wherein a) the conduit comprises an adhesive inlet opening in the enveloping surface of the sonotrode in the region of a vibration node, a longitudinal orifice extending through the adhesive outlet opening and a transverse orifice extending through the adhesive inlet opening, b) the adhesive outlet opening is arranged in the end surface of the exposed head end of the sonotrode and c) the apparatus additionally comprises an adhesive pump that is connected to a regulating circuit for regulating the quantity of the adhesive delivered.

12. The apparatus of claim 1, wherein a) the apparatus additionally comprises an adhesive pump that is connected to a regulating circuit for regulating the quantity of the adhesive delivered, b) the regulating circuit is acted upon by an input variable that corresponds to the value of the power consumption of the sonotrode, and c) a temperature sensor is arranged in the region of the exposed head end of the sonotrode.

13. The apparatus of claim 1, wherein a) the conduit comprises an adhesive inlet opening in the enveloping surface of the sonotrode in the region of a vibration node, a longitudinal orifice extending through the adhesive outlet opening and a transverse orifice extending through the adhesive inlet opening and b) the adhesive outlet opening is arranged in the end surface of the exposed head end of the sonotrode.
